(19) United States
(12) Patent Application Publication
(10) Pub. No.: US 2008/0136845 A1
(43) Pub. Date: Jun. 12, 2008

(54) IMAGE DISPLAY METHOD AND IMAGE DISPLAY DEVICE USING THE SAME

(75) Inventor: Kunifumi Nakanishi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/950,770

(22) Filed: Dec. 5, 2007

(30) Foreign Application Priority Data
Dec. 6, 2006 (JP) P2006-329275

(51) Int. Cl. G09G 5/10

(52) U.S. Cl. 345/690

(57) ABSTRACT

In the case where a first bit number of a picture signal entered to a driver unit for driving an image display device is larger than a second bit number of display data outputted from the driver unit, a display method for displaying an image in such a gradation of the first bit number on the image display device is realized by that a first region and a second region are provided within an entire gradation region of the driver unit. In the first region, the FRC is carried out by defining the first frame number as one set so as to add pseudogradation. In the second region, the FRC is not carried out. The second region is assumed as such a gradation region that when the field angle of the image display device is deflected, a gradient of a gradation-to-luminance characteristic becomes steep.

This application claims priority from Japanese Patent Application No. 2006-329275 filed on Dec. 6, 2006, the entire subject matter of which is incorporated herein by reference.

### BACKGROUND OF THE INVENTION

1. Field of the Invention

The present invention relates to an image display method, and an image display device using the image display method. More specifically, the present invention is related to an image display method for representing intermediate gradation by employing an FRC method based upon a plurality of frames, and related to a drive circuit of the image display device. In particular, the image display method and the image display device of the present invention can be suitably utilized in an active matrix type liquid crystal device with employment of thin-film transistors.

2. Description of the Related Art

To drive active matrix type liquid crystal panels employing TFTs (Thin-Film Transistors), data driver units for sending out data signals and scanning driver units for performing line sequential scanning operations are employed. Normally, predetermined gradation displays are carried out by changing magnitudes of applied voltages which correspond to voltage-to-luminance characteristics of liquid crystal panels.

Also, a frame rate control (will be referred to as “FRC” hereinafter) method is well known in the technical field as one of such methods that while gradation is specifically held in the data driver unit itself, this data driver unit performs a multi-gradation display whose gradation number is higher than, or equal to the maximum gradation number in such a gradation capable of being outputted (will be referred to as “specific gradation “hereinafter). This technical idea is given as follows: That is, the gradation display is performed by selectively controlling the specific gradation data held in the data driver unit among frames so as to change effective values of liquid crystal drive voltages (refer to, for example, NIKKEI ELECTRONICS/NIKKEI MICRODEVICE EDITION [Flat Panel Display 1991], pages 173 to 180, issued by NIKKEI BP company on Nov. 26, 1990).

More precisely speaking, while “m (m≧2)” frames are used as 1 period with respect to a display of a pixel 1 dot, specific gradation “Gₚ” is displayed within “n (n>0, n<m)” frames, and specific gradation “G_{q}” is displayed in the remaining (m−n) frames. As a result, due to a weighted time mean of a frame rate between the gradation Gₚ and the gradation G_{q}, intermediate gradation between certain specific gradation of the data driver unit and other specific gradation thereof is displayed in a pseudo-display manner (hereinafter, “intermediate gradation” will be referred to as “pseudogradation” hereinafter, that is, a symbol G on which a suffix letter is attached to the symbol G represents a gradation value of the specific gradation; and suffix letters “p” and “q” constitute integers indicative of specific gradation values contained by data driver unit).

For example, while 4 frames (m=4) are defined as one set, the gradation Gₚ is displayed for 3 frames (n=3) within the 4 frames, whereas the gradation G_{q} is displayed for the remaining 1 frame. A luminance level which can be visibly recognized at this time corresponds to a weighted time mean of a frame rate between the gradation Gₚ and the gradation G_{q}(Lₚ×¾+L_{q}¼). In this case, symbols “Lₚ” and “L_{q}” indicate visible luminance levels corresponding to the respective gradation Gₚ and G_{q}. Similarly, a luminance level which can be visibly recognized in such a case that the gradation Gₚ and the gradation G_{q} are displayed for 2 frames within the 4 frames respectively becomes (Lₚ× 2/4+L_{q}× 2/4)={(Lₚ+L_{q})/2}. Furthermore, a luminance level which can be visibly recognized in such a case that the gradation Gₚ is displayed for 1 frame within the 4 frames and the gradation G_{q} is displayed for the remaining 3 frames becomes (Lₚ¼+L_{q}×¾).

Generally, when a gradation number of “j bits (i<j)” is displayed on a data driver unit having a specific gradation number of “i bits” by way of the above-explained FRC system, while 2^{(j-i)} frames are defined as one set, {2^{(j-i)}−1} pieces of pseudogradation are produced between respective gradation of the i bits, and {2^{j}−2^{(j-i)}+1} pieces of gradation are displayed (suffix letter subsequent to “2” indicates power index number). In this case, since two pieces of such gradation having different luminance levels are alternately displayed every frame, there are some possibilities that flickering as to the produced pseudogradation can be visibly recognized by human eyes. Generally, the easier this flickering can be visibly recognized, the larger a difference between “brightnesses” of two pieces of the gradation is increased, or the longer a variation period of “brightness” becomes. As a consequence, when the pseudogradation is produced by employing the FRC, practically speaking, both the difference between “brightnesses” of two pieces of the gradation, and also, the variation period (frame number) of “brightness” must be set in order that the flickering never causes a problem. In this case, the expression “brightness” implies a sensible amount by a person, and has a dependent characteristic with respect to luminance of a visibly recognizable portion on a display screen, luminance of a background portion thereof, and furthermore, illuminance of a visibly recognizable environment.

On the other hand, FIG. 6, (a-2) of H. Mori, H. Itoh, Y. Nishiura, T. Nakamura and Y. Shinagawa “Optical Performance of Novel Compensation Film for Wide-Viewing-Angle TN-LCDs”, pages 189 to 192, Proc. IDW ‘96/AM-LCD’ 96 exemplifies the change in the gradation-to-luminance characteristic when the visible recognizable direction is changed in the upper and lower azimuth with respect to a general-purpose normally white twistnematic type liquid crystal panel (will be referred to as “NW-TN LCD panel” hereinafter) which has employed the field angle correction film. When the NW-TN LCD panel is visibly recognized from the upper field angle in this drawing, the following fact can be revealed: That is, the luminance difference between the gradation in the lower gradation region becomes 2 to 3 times larger than that in such a case that NW-TN LCD panel is visibly recognized from the normal direction (0 degree). It should be noted that a field angle will be referred to as a deflection angle from a normal direction when a viewer visibly recognizes a display device. Similarly, when the NW-TN LCD panel is visibly recognized from the lower field angle, it can also be revealed that the luminance difference between the gradation in the higher gradation region becomes 2 to 3 times larger than that in such a case that NW-TN LCD panel is visibly recognized from the normal direction. As previously explained, when the visible recognizable direction is changed in the upper and lower azimuth, the luminance difference between the gradation is increased. Furthermore, in accordance with FIG. 15 of “APPLICATION OF POLYMER LIQUID CRYSTAL FILM TO DISPLAY DEVICE” written by Toyooka and Kobori, “EKISHO” (Japanese Liquid Crystal Institute) volume 4, No. 2, pages 159 to 164, issued on Apr. 25, 2000, when the visible recognizable direction is changed in the right and left azimuth, there are some possibilities that the luminance difference between the gradation becomes large. There is such a problem that when the field angle is deflected from the normal direction to either the upper/lower directions or the right/left directions in the pseudogradation formed by the FRC, the flickering may be easily and visibly recognized.

Moreover, generally, in liquid crystal display devices with employment of NW-TN LCD panels which do not employ field angle correcting films (used in notebook type computers etc.), the following problem similarly occurs. That is, as apparent from FIG. 6 and (b-2) of H. Mori, H. Itoh, Y. Nishiura, T. Nakamura and Y. Shinagawa “Optical Performance of Novel Compensation Film for Wide-Viewing-Angle TN-LCDs”, pages 189 to 192, Proc. IDW ‘96/AM-LCD’ 96, and FIGS. 3 and 4 of JP-A-10-339865, when the NW-TN LCD panels are visibly confirmed from the upper and lower azimuth, the luminance differences between the gradation in both the higher and lower gradation regions are increased. Therefore, if the pseudogradation formed by the FRC is employed in these higher/lower gradation regions, then the flickerings may be readily and visibly recognized.

Generally, when a gradation number of “j bits (i<j)” is displayed on a data driver unit having a specific gradation number of “i bits” by way of the above-explained FRC system, while 2^{(j-i)} frames are defined as one set, {2^{(j-i)}−1} pieces of pseudogradation are produced between respective gradation of the i bits. As a result, a total number of gradation which can be displayed becomes {2^{j}−2^{(j-i)}+1} which is calculated by adding 2ⁱ pieces of the specific gradation outputted from the data driver unit irrespective of the FRC to [{2^{(j-i)}−1}×(2⁽ⁱ⁻¹⁾)] pieces of the pseudogradation which are produced by the FRC. Accordingly, there is a shortage of {2^{(j-i)}−1} pieces with respect to the total number (2^{j}) of the j-bit gradation to be displayed. In this case, generally, 2^{(j-i)} pieces of the gradation among 2^{j} pieces of the gradation of the input image signal are displayed in the same gradation level, so that a so-called “gradation collapse” may be produced as a display image. In order to solve the problem of “gradation collapse” and to obtain the shortage of gradation components, the following method may be taken: That is, {2^{(j-i+1)}−2} pieces of pseudogradation are produced only between certain gradation Gᵣ and gradation Gᵣ₊₁ so as to perform 2^{j} pieces of gradation display in total, while {2^{j-i+1)}−1} frames are defined as one set. These frames are equal to such a frame number obtained by adding the above-described 2^{(j-i)} frames number to another frame number of {2^{(j-i)}−1} equal to the shortage of the gradation number. This pseudogradation by the FRC while {2^{(j-i+1)}−1} pieces of frames are defined as one set is set to the higher gradation side and the lower gradation side, which can be relatively and hardly recognized when the display device is visibly recognized from the front plane, since the variation period (frame frequency) of the brightness is large, and the flickering can be easily and visibly recognized (see JP-A-2006-119417 (FIG. 7, paragraphs [0066 to 0067])). In accordance with the above-described setting operation, in the above-described image display device having the field angle dependent characteristic, there is another problem that such a problem that the flickering may be visibly recognized when the field angle is deflected may become conspicuous.

### SUMMARY OF THE INVENTION

The present invention has been made to solve the above problems. An object of the present invention is to provide an image display method capable of displaying an image by reducing flickering, and also, to provide an image display device using this image display method.

An image display method, according to the present invention, is featured by such a display method by which when a first bit number of image data inputted to an image display device is larger than a second bit number of display data inputted to a driver unit for driving a display unit, an image of the image data is displayed on the image display device in gradation of the first bit number, wherein: a first region where a frame rate control is performed by defining a first frame number as one set so as to produce pseudogradation; and a second region where the frame rate control is not carried out are provided in a gradation region of the driver unit; and wherein: the second region is such a gradation region that when a field angle of the image display device is deflected from the normal direction to a predetermined field angle direction, or a predetermined angle, a gradient of a gradation-to-luminance characteristic becomes steep.

Also, an image display device, according to the present invention, is such a display device with employment of the above-described image display method.

In accordance with the image display method described in the present invention, in the display device, the visibility of flickering can be reduced.

### BRIEF DESCRIPTION OF THE DRAWINGS

FIG. 1 is a structural diagram of an image display device according to embodiments 1 to 4 of the present invention;

FIG. 2 is a structural diagram of an FRC circuit according to the embodiment 1 of the present invention;

FIG. 3 is a gradation-to-luminance characteristic diagram of the image display device according to the embodiment 1 of the present invention;

FIG. 4 is a structural diagram of an FRC circuit according to the embodiment 2 of the present invention;

FIG. 5 is a gradation-to-luminance characteristic diagram of the image display device according to the embodiment 2 of the present invention;

FIG. 6 is a structural diagram of an FRC circuit according to the embodiment 3 of the present invention;

FIG. 7 is a gradation-to-luminance characteristic diagram of the image display device according to the embodiment 3 of the present invention;

FIG. 8 is a structural diagram of a 7-frame FRC circuit according to the embodiment 4 of the present invention; and

FIG. 9 is a gradation-to-luminance characteristic diagram of a liquid crystal panel according to the embodiments 1 to 4 of the present invention.

### DETAILED DESCRIPTION OF THE PREFERRED EMBODIMENTS

Referring now to drawings, a description is made of embodiments of the present invention. In order to avoid that descriptions are repeatedly made to become redundant, the same reference numerals will be employed as those for denoting structural elements having the same, or similar functions in the respective drawings.

### Embodiment 1

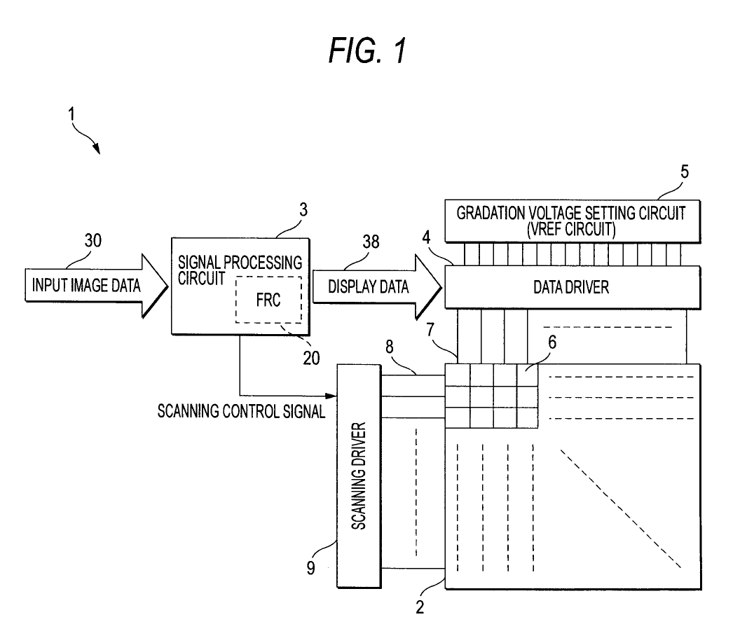

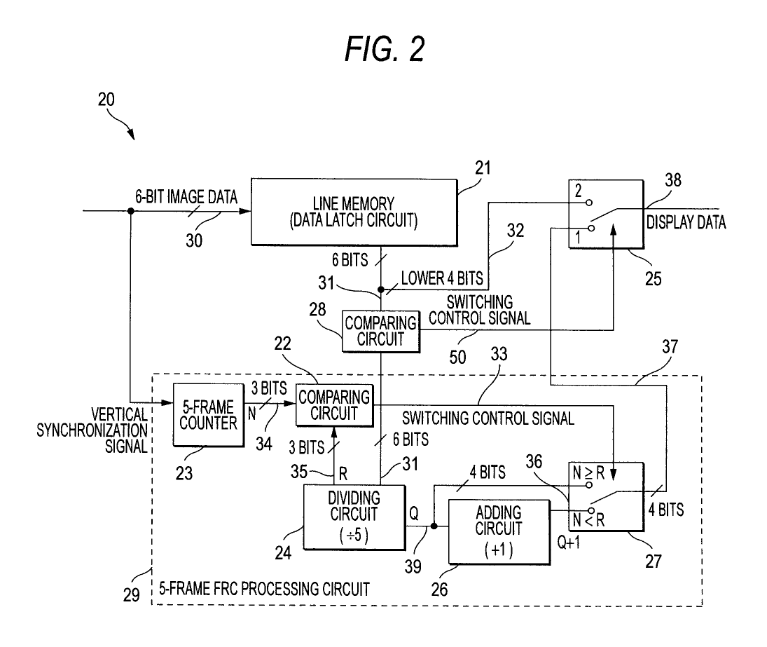

FIG. 1 shows a schematic structural diagram of a liquid crystal device 1 according to an embodiment 1 of the present invention. FIG. 2 is a structural diagram of an FRC processing circuit 20 which is built in a signal processing circuit 3 shown in FIG. 1. In FIG. 1, a liquid crystal panel 2 (display unit) has contained a plurality of pixels 6 at intersected portions between scanning lines 8 and signal lines 7, which have been arranged in a matrix shape. These plural pixels 6 are driven by TFTs (not shown) connected to the scanning lines 8 and the signal lines 7. Also, the scanning lines 8 are driven by a scanning driver unit 9, and the signal lines 7 are driven by a data driver unit 4, respectively. In the embodiment 1, since the above-described driving system of the scanning lines 8 and the signal line 7 has employed a general-purpose line sequential driving system, and is well known in the technical filed, detailed descriptions thereof are omitted.

Also, the data driver unit 4 for driving the signal lines 7 has a 4-bit specific gradation (namely, 16 values of gradation). In order to define voltage levels of 16 stages corresponding to this 4-bit specific gradation, 16 pieces of reference voltages (Vref) are entered from a gradation voltage setting circuit 5 to the data driver unit 4.

A signal processing circuit 3 is such a processing circuit which inputs thereinto 6-bit image data 30 to be displayed on the above-described liquid crystal panel 2, and which outputs 4-bit display data 38 to the data driver unit 4, and a scanning control signal to the scanning driver unit 9 respectively. The signal processing circuit 3 contains the FRC processing circuit 20 for realizing multi-gradation by which an image having gradation equivalent to 6 bits is displayed on the liquid crystal panel 2.

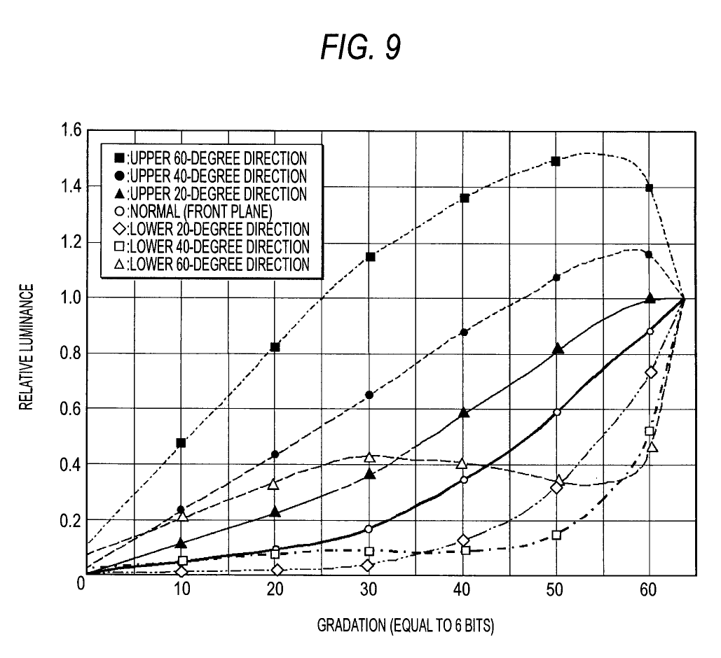

FIG. 9 represents an example of a gradation-to-luminance characteristic when a visibility characteristic is changed in upper azimuth and lower azimuth with respect to the liquid crystal panel 2 which corresponds to an NW-TN LCD panel and has been employed in the embodiment 1 of the present invention. As represented in FIG. 9, in the case that the liquid crystal panel 2 is visibly confirmed from an angle of field of either a lower direction or an upper direction in higher gradation (namely, 60 gradation to 63 gradation converted into 6 bits in this drawing) with respect to the gradation/luminance characteristic when the liquid crystal panel 2 is visibly confirmed from a front plane direction, the luminance changed with respect to the gradation becomes very large. For instance, when relative luminance of 63 gradation along each of the field angle directions is assumed as 1.00, relative luminance of 62 gradation along the front view direction is 0.95, whereas relative luminance of 62 gradation at lower 20 degrees of the field angle direction is 0.87; relative luminance of 62 gradation at lower 40 degrees of the field angle direction is 0.77; and furthermore, relative luminance of 62 gradation at lower 60 degrees of the field angle direction is 0.73; and similarly, relative luminance of 62 gradation at upper 40 degrees of the field angle direction is 1.08; and relative luminance of 62 gradation at upper 60 degrees of the field angle direction is 1.2. As a consequence, in the embodiment 1, the liquid crystal panel 2 has been arranged by not employing the FRC processing operation especially in the higher gradation region where the luminance change caused by the field angle is large.

FIG. 2 is a structural diagram of the above-described FRC processing circuit 20. In FIG. 2, a line memory 21 is a memory for storing thereinto image data 30 (6-bit data) for 1 line which is displayed on the liquid crystal panel 2 in order to execute a signal processing operation later. The line memory 21 is constructed of a plurality of 6-bit data latch circuits (not shown). Image data for 1 line which is stored in the line memory 21 is updated every 1 horizontal period. Precisely speaking, image data are sequentially written in this line memory 21 in such a manner that image data for 1 lower line is written every 1 horizontal period from such an image data corresponding to the uppermost line on the screen of the liquid crystal panel 2. After such an image data corresponding to the lowermost line has been written, another image data for the uppermost line corresponding to a next screen is written in this line memory 21 via a vertical blanking period. Subsequently, a series of the above-described image data storage operation is repeatedly carried out. 6-bit image data 31 outputted from the line memory 21 is inputted to the comparing circuit 28, and then, image data 32 produced by deriving lower 4 bits from the 6-bit image data 31 (namely, upper 2 bits thereof are discarded) is inputted to a switching circuit 25. A comparing circuit 28 directly outputs the entered image data 31 to a dividing circuit 24, and outputs a switching control signal 50 to the switching circuit 25. The switching circuit 25 switches an output 37 (4 bits) of a 5-frame FRC processing circuit 29 and the above-described image data 32 in accordance with a switching control signal 50. An output of the switching circuit 25 is entered as display data 38 to the data driver unit 4.

Next, a description is made of an arrangement of the 5-frame FRC processing circuit 29. A comparing circuit 22 employed in the 5-frame FRC processing circuit 29 inputs a frame number 34 from a 5-frame counter 23, and furthermore inputs a remainder R (35) from the dividing circuit 24. The dividing circuit 24 divides the image data 31 inputted from the comparing circuit 28 by a constant of 5, and then, outputs a quotient Q (39) thereof to both a switching circuit 27 and an adding circuit 26. Also, the dividing circuit 24 outputs the remainder R (35) of the above-described division to the comparing circuit 22.

In this case, operations of the switching circuit 25 will be firstly explained. The line memory 21 which has stored the image data 30 for 1 line outputs the image data 31 to the comparing circuit 28, the dividing circuit 24, and the switching circuit 25 in synchronism with a predetermined clock signal (not shown). It should be noted that normally, such a clock signal is used as the predetermined clock signal, which is identical to, or is synchronized with the dot clock of the image signal 30. Also, only lower 4 bits of the image data 31 are separated therefrom, and then, the separated lower 4 bits are outputted as the image data 32 to the switching circuit 25. On the other hand, the 6-bit image data 31 is directly inputted to the comparing circuit 28. When the image data 31 has gradation “D₆₀” to “D₆₃”, the above-explained 4-bit image data 32 is switched in response to a control signal 50 of the comparing circuit 28, and then, is outputted as display data 38 via the switching circuit 25 (subsequently, such a symbol that subscript numeral is attached to symbol “D” represents gradation value of image data 30, or image data 31, and exemplifies 6-bit gradation in this embodiment 1, so that subscript numerals employ 0 to 63).

Next, a detailed description is made of operations of the 5-frame FRC processing circuit 29. As previously described, when the image data 31 has the gradation D₆₀ to D₆₃, the output of the 5-frame FRC processing circuit 29 is cut off by the switching circuit 25, and thus, does not constitute the output for the display data 38. On the other hand, when the image data 31 has the gradation Do to D₅₉, the switched output (=output 37 of the 5-frame FRC processing circuit) of the switching circuit 27 constitute the display data 38. In this case, as previously explained, when the 6-bit image data 31 is inputted to the dividing circuit 24 in synchronism with the predetermined clock signal, if the gradation values “0” to “59” (digital image data values) of this image data 31 is divided by the constant of 5, then quotient numbers of this division result become values from 0 to 11, in correspondence with the gradations D₀ to D₅₉. The dividing circuit 24 outputs these values 0 to 11 as a quotient Q (39) to the switching circuit 27 and the adding circuit 26 (4-bit data). The adding circuit 26 inputs the above-described quotient Q (39) and adds 1 to this quotient Q (39), and then, outputs values of 1 to 12 in response to the input values 0 to 11 to the switching circuit 27 as an added result Q+1 (36). In other words, while the quotient Q (39) and the added result Q+1 (36) are continuously entered to the switching circuit 27, the quotient Q (39) and the added result Q+1 (36) are exclusively switched in response to the switching control signal 33, and then, the switched output (=output 37 of the 5-frame FRC processing circuit) is transferred via the switching circuit 25 as display data 38, namely, sent to the switching circuit 25 as gradation values 0 to 12 which correspond to specific gradation “G₀” to “G₁₂” of the data driver unit 4.

The comparing circuit 22 compares the above-described remainder R (35) derived from the dividing circuit 24 with a frame number N (34) corresponding to an output of the 5-frame counter 23 so as to output the switching control signal 33 to the switching circuit 27 in such a manner that if the frame number N (34) is N<R, then the added result Q+1 (36) is outputted from this switching circuit 27, whereas if the frame number N (34) is N≧R, then the quotient Q (39) is outputted therefrom.

In this case, the 5-frame counter 23 corresponds to such a free run counter. That is, a count value of the free run counter is counted up every time a vertical synchronization signal of the image data 30 is entered, so that 5 pieces (namely, 0, 1, 2, 3 and 4) of frame numbers (first frame numbers) N (34) are produced as one set to be sequentially outputted; and when another vertical synchronization signal is inputted subsequent to the frame number of 4, the count value of this free run counter is returned to 0 (in other words, frame numbers are circulated in this manner from 0, 1, 2, 3, 4, 0, 1, 2, . . . ). Since the frame number N (34) is compared with the remainder R (35) in the above-described manner, when the remainder R (35) is 0, the quotient Q (39) is outputted from the switching circuit 27 irrespective of the frame number N (34). When the remainder R (35) is 1, the added result Q+1 (36) is outputted from the switching circuit 27 only for one frame within 5 frames; and the quotient Q (39) is outputted from the switching circuit 27 within the remaining 4 frames. Also, when the remainder R (35) is 2, the added result Q+1 (36) is outputted from the switching circuit 27 only for two frames within 5 frames; and the quotient Q (39) is outputted from the switching circuit 27 within the remaining 3 frames. The remainder R (35) becomes an integer larger than, or equal to 0 and smaller than 5 in a similar manner. As a result, the added result Q+1 (36) is outputted from the switching circuit 27 only for an R frame within 5 frames; and the quotient Q (39) is outputted from the switching circuit 27 within the remaining (5-R) frames. As a consequence, a value of gradation averaged for 5 frames, namely, a value of pseudogradation may be expressed as {R×(Q+1)+(5-R)×Q}/5. In other words, the inputted image data 31 is divided by the constant of 5 to obtain the quotient Q (39) (4-bit value) and the remainder R (35), so that since these quotient Q (39) and remainder R (35) are used, 4 pieces of pseudogration can be produced between the quotient Q (39) gradation and the quotient Q (39)+1 gradation in response to the remainder R (35).

As previously described, in the embodiment 1, since the comparing function of the comparing circuit 22 is employed, when the gradation of the image data 31 corresponds to the gradation D₆₀, D₆₁, D₆₂, and D₆₃, the lower 4 bits thereof become the image data 32 (namely, gradation of image data 32 are specific gradation values 12, 13, 14, 15 corresponding thereto respectively). Also, when the gradation of the image data 31 is smaller than the gradation D₆₀, D₆₁, D₆₂, and D₆₃, the output 37 (4 bits) of the 5-frame FRC processing circuit 29 constitutes the image data 32. While the comparing function of the comparing circuit 22 is employed in the FRC processing circuit 29, 4 pieces of pseudogradation are produced between the respective adjacent gradation of the specific gradation G₀ to G₁₂ by the FRC function based upon the 12 gradation from G₀ to G₁₁. As a consequence, a total number of gradation including the specific gradation and the pseudogradation becomes 12×5=60, and then, 4 pieces of the gradation in case of the gradation D₆₀, D₆₁, D₆₂, and D₆₃ are added to the total 60 gradation values, so that 64 gradation equivalent to 6 bits may be realized.

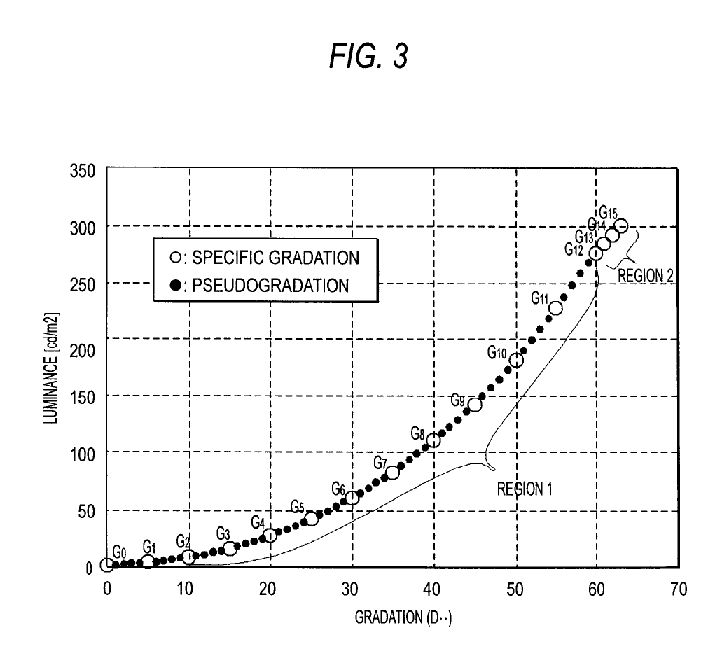

FIG. 3 represents one example of a gradation characteristic of the above-explained 64 gradation, namely, a luminance characteristic (namely, gradation-to-luminance characteristic) of the image data 31 and the liquid crystal display device 1 in the embodiment 1.

FIG. 3 shows such a gradation-to-luminance characteristic when the gradation (64 gradation in total number) equivalent to 6 bits are obtained by the FRC by employing the data driver unit 4 (16 gradation in total specific gradation number) having an output of 4 bits (namely specific gradation number). In this gradation/luminance characteristic, plotted symbol of “∘” indicates luminance of each of the 4-bit specific gradation (represented by G₀ to G₁₅), whereas plotted symbol of “” indicates luminance of 6-bit intermediate gradation which are produced in the pseudomanner by employing the FRC. In the embodiment 1, the gradation D₆₀ to the gradation D₆₃ (in FIG. 3, region 2: second region) are set to 4-bit gradation which can be directly outputted from the data driver unit 4 irrespective of the FRC. At this time, since the 4-bit gradation number which can be directly outputted from this data driver unit 4 corresponds to 16 gradation, the 6-bit gradation Do to D₅₉ (in FIG. 3, region 1: first region) must be produced based upon the remaining 12 gradation by the FRC function. As a consequently, assuming now that a total frame number of the FRC executed by employing the 4-bit specific gradation G₀ to G₁₂ is 5 frames, 4 pieces of the pseudogradation have been formed between the respective gradation.

As previously described, if the image display method according to the embodiment 1 of the present invention is employed, then the below-mentioned advantages may be obtained. That is, with respect to such an image display apparatus having the field angle depending characteristic known as a liquid crystal display device, in a gradation region in which a gradient of a gradation-to-luminance characteristic caused by an angle of field becomes steep (namely, in embodiment 1, higher gradation region whose specific gradation is higher than, or equal to G₁₂), the gradation is set to this gradation region based only on the specific gradation which can be directly outputted from the data driver unit 4 without providing the pseudogradation by the FRC (Frame Rate Control). As a result, even when the field angle is deflected, the image display apparatus can display the image in the multi-gradation mode while the flickering can be reduced.

Also, in the embodiment 1 of the present invention, as the simple method for setting (selecting) the specific gradation which is directly outputted from the data driver unit 4 without using the FRC, such a method has been employed by which the lower bits of the image data 31 on the higher gradation side are extracted to be used. Alternatively, another method may be employed by which the specific gradation is selected which is directly outputted on the lower gradation side (for example, 0 to 3 gradation) of the image data 31. Furthermore, as another method, a subtracting circuit may be employed. In the case of the embodiment 1 of the present invention, such a calculation result obtained by subtracting a constant of 48 from the image data 31 may be alternatively employed as the specific gradation on the higher gradient side.

It should be understood that in the description of the embodiment 1, as one embodiment (namely, example of display device employing NW-TN LCD panel) of the gradation region in which the gradient of the gradation/luminance characteristic becomes steep when the field angle is deflected along the specific direction (namely, gradation region without using FRC), the higher gradation region has been employed.

However, in a liquid crystal display device, with respect to each of multiple liquid crystal modes and each of liquid crystal orientation statuses, such a relationship among a range of gradation regions in which gradients of gradation-to-luminance characteristics become steep and thus flickering can be easily and visibly confirmed, directions and angles along which a field angle from a normal direction of the liquid crystal display device is deflected is not constant. Accordingly, it is necessarily required to set such a gradation region where the above-described FRC is not performed in correspondence with a predetermined field angle direction and a preselected angle by a visible test, or the like, while each of the field angle depending characteristics of the gradation/luminance characteristics as to various sorts of liquid crystal display device is grasped.

The above-described setting of the gradation region may be similarly applied to display devices other than liquid crystal type display devices.

### Embodiment 2

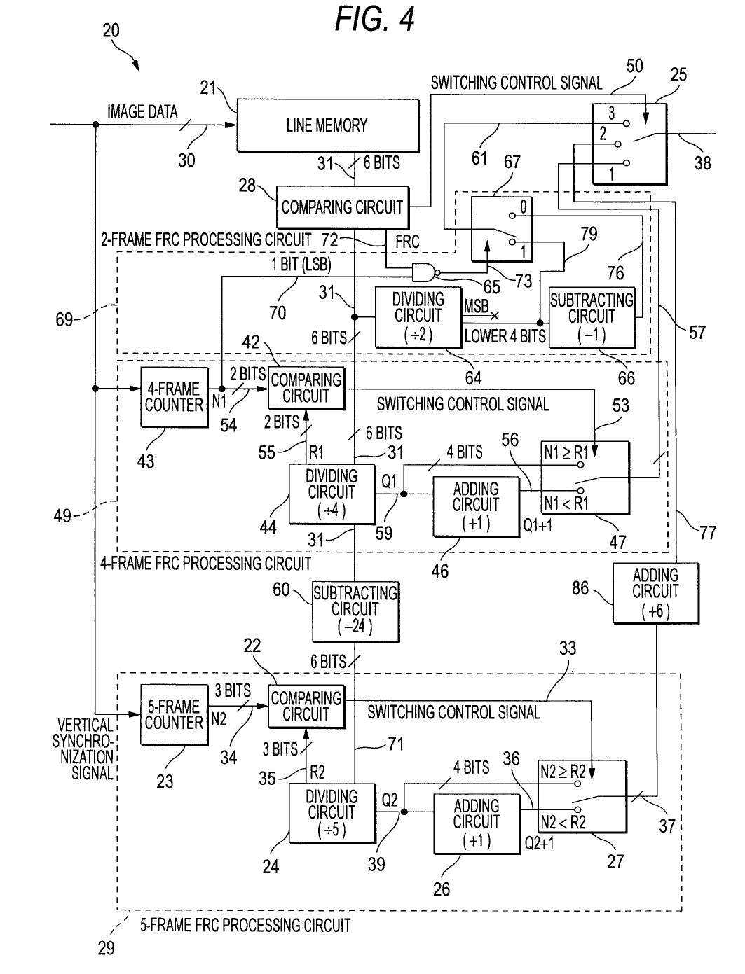

With respect to a liquid crystal display device according to an embodiment 2 of the present invention, schematic arrangements of signal processing circuits and the like except for a liquid crystal panel, a data driver unit, a scanning driver unit, and an FRC circuit are the same as those of the above-described embodiment 1, and therefore, detailed descriptions thereof are omitted. A detailed description is made of different points from the embodiment 1. FIG. 4 is a structural diagram of an FRC processing circuit 20 according to this embodiment 2. In FIG. 4, a line memory 21 corresponds to such a memory for storing thereinto image data 30 for 1 line which is displayed on a liquid crystal panel 2 in order to perform a signal processing operation later. A structure and a function of this line memory 21 are identical to those of the embodiment 1, and thus, detailed explanations thereof are omitted. Also, the liquid crystal panel 2 employed in the embodiment 2 is identical to that of the above-described embodiment 1, and in particular, the liquid crystal panel 2 of the embodiment 2 has employed a 2-frame FRC processing operation in a higher gradation region where a luminance change caused by a field angle is large.

The FRC processing circuit 20 provided in the embodiment 2 has been arranged by a 2-frame FRC processing circuit 69, a 4-frame FRC processing circuit 49, a 5-frame FRC processing circuit 29, and also, an adding/subtracting circuit 60. A comparing circuit 28 selectively switches outputs 61, 57, 37 (in actual, output 77 of the adding circuit) from 3 sorts of the FRC processing circuits based upon values of gradations (D₀ to D₆₃) of the image data 31 so as to produce display data 38.

Precisely speaking, the comparing circuit 28 controls the switching circuit 25 in such a manner that when the image data 31 has the gradations D₅₉ to D₆₃, the switching circuit 25 is switched to the output 61 of the 2-frame FRC processing circuit 69; when the image data 31 has the gradation D₂₄ to D₅₈, the switching circuit 25 is switched to the output 37 of the 5-frame FRC processing circuit 29; and also, when the image data 31 has the gradation D₀ to D₂₃, the switching circuit 25 is switched to the output 57 of the 4-frame FRC processing circuit. An output of the switching circuit 25 is entered as the display data 38 to the data driver unit 4.

Next, a detailed description is made of operations of the 4-frame FRC processing circuit 49. As previously described, when the image data 31 has gradation other than D₀ to D₂₃, the output of the 4-frame FRC processing circuit 49 is cut off by the switching circuit 25, and thus, does not constitute the output for the display data 38. On the other hand, when the image data 31 has the gradation D₀ to D₂₃, the switched output 57 of the switching circuit 47 constitutes the display data 38. In this case, similar to the embodiment 1, as shown in FIG. 4, when the 6-bit image data 31 is inputted to the dividing circuit 44 in synchronism with the predetermined clock signal, if the gradation values “0” to “23” (digital image data values) of this image data 31 is divided by the constant of 4, then quotient numbers of this division result become values from 0 to 5, which correspond to the gradation D₀ to D₂₃. The dividing circuit 44 outputs these values 0 to 5 as a quotient “Q1 (59)” to the switching circuit 47 and the adding circuit 46 (3-bit data). The adding circuit 46 inputs the above-described quotient Q (39) and adds 1 to this quotient Q1 (59), and then, outputs values of 1 to 6 in response to the input values 0 to 5 to the switching circuit 47 as an added result “Q1+1 (56). In other words, while the quotient Q1 (59) and the added result “Q1+1 (56)” are continuously entered to the switching circuit 47, the quotient Q1 (59) and the added result “Q1+1 (56)” are exclusively switched in response to the switching control signal 53, and then, the switched output 57 is transferred to the switching circuit 25.

The comparing circuit 42 compares a remainder R1 (55) derived from the dividing circuit 44 with a frame number N1 (54) corresponding to the output of the 4-frame counter 43 so as to output a switching control signal 53 to the switching circuit 47 in such a manner that if the frame number N1 (54) is N1<R1, then the added result “Q1+1 (56)” is outputted from this switching circuit 47, whereas if the frame number N1 (54) is N1≧R1, then the quotient Q1 (59) is outputted therefrom.

In this case, the 4-frame counter 43 corresponds to such a free run counter. That is, a count value of the free run counter is counted up every time a vertical synchronization signal of the image data 30 is entered, so that 4 pieces (namely, 0, 1, 2, and 3) of frame numbers (first frame numbers) N1 (54) are produced as one set to be sequentially outputted; and when another vertical synchronization signal is inputted subsequent to the frame number of 3, the count value of this free run counter is returned to 0 (in other words, count values are circulated in this manner from 0, 1, 2, 3, 0, 1, 2, . . . ) Since the frame number N1 (54) is compared with the remainder R (55) in the above-described manner, when the remainder R1 (55) is 0, the quotient Q1 (59) is outputted from the switching circuit 47 irrespective of the frame number N1 (54). When the remainder R1 (55) becomes 1, the added result Q1+1 (56) is outputted from the switching circuit 47 only for one frame within the 4 frames, and the quotient Q1 (59) is outputted from the switching circuit 47 within the remaining 3 frames. When the remainder R1 (55) becomes 2, the added result Q1+1 (56) is outputted from the switching circuit 47 only for two frames within the 4 frames, and the quotient Q1 (59) is outputted from the switching circuit 47 within the remaining 2 frames. Since the remainder R1 (55) becomes an integer larger than, or equal to 0, and smaller than 4 in a similar manner, the added result Q1+1 (56) is outputted from the switching circuit 47 only for an R1 frame within 4 frames; and the quotient Q1 (59) is outputted from the switching circuit 47 within the remaining (4-R) frames. As consequence, a value of gradations averaged for 4 frames, a pseudogradation value may be expressed as [R1×(Q1+1)+(4-R1)×Q1}/4. In other words, the inputted image data 31 is divided by the constant 4 to obtain the quotient Q1 (59) (3-bit value) and the remainder R1 (55), so that since these quotient Q1 (59) and remainder R1 (55) are used, 3 pieces of pseudogradation can be produced between the quotient Q1 (59) gradation and the quotient Q1 (59)+1 gradation in response to the remainder R1 (55).

As previously described, while the comparing function of the comparing circuit 22 is employed in correspondence with the gradation D₀ to D₂₃, the 4-frame FRC processing circuit 49 produces 3 pieces of the pseudogradation between the respective adjacent gradation of the specific gradation G₀ to G₆ by the FRC function based upon the 6 specific gradation from G₀ to G₅. As a consequence, a total number of gradation including the specific gradation and the pseudogradation becomes 6×4=24, so that the 4-frame FRC processing circuit 49 may realize 24 gradation equivalent to 6 bits in correspondence with the gradation D₀ to D₂₃.

Next, a detailed description is made of operations of the 2-frame FRC processing circuit 69. As previously described, when the image data 31 has gradation other than gradation D₅₉ to D₆₃, the output of the 2-frame FRC processing circuit 69 is cut off by the switching circuit 25, and thus, does not constitute the output of the display data 38. On the other hand, when the image data 31 has the gradation D₅₉ to D₆₃, the switched output (namely, output 61 of the 2-frame FRC processing circuit) of the switching circuit 67 constitutes the display data 38. In this case, as shown in FIG. 4, while the 6-bit image data 31 is inputted to the dividing circuit 64 in synchronism with the above-described predetermined clock signal, if the gradation values 59 to 63 (digital image data values) of this 6-bit image data 31 is divided by a constant of 2, as a result, when the gradation value of the image data 31 is the gradation D₅₉, the quotient becomes 29; when the gradation values of the image data 31 are the gradation D₆₀ and D₆₁, the quotient becomes 30; and when the gradation values of the image data 31 are the gradation D62 and D₆₃, the quotient becomes 31 (remainder is discarded). The dividing circuit 64 extracts lower 4 bits of these values 29 to 31 (otherwise, to perform subtraction process for subtracting constant of 16), and then outputs the extracted lower 4 bits to the switching circuit 67 and the subtracting circuit 66 as an output 79. As a consequence, when the gradation is D₅₉, 13 is outputted to the subtracting circuit 66 and the switching circuit 67; when the gradation is D₆₀ and D₆₁, 14 is outputted thereto; and when the gradation is D₆₂ and D₆₃, 15 is outputted thereto.

On the other hand, as a second control output of the comparing circuit 28, an FRC (72) is inputted as one terminal of a NAND circuit 65, and an LSB output 70 of a 4-frame counter 43 is inputted to the other terminal (symbol “LSB” implies Less Significant Bit). In this case, when the gradation D₆₀ and D₆₂ (namely, correspond to pseudogradation) which require the FRC function is inputted as the image data 31, the comparing circuit 28 sets the FRC (72) as “1”, whereas when any gradation other than the above-described gradation D₆₀ and D₆₂ are inputted, namely, the image data 31 have the gradation D₅₉, D₆₁, D₆₃, the comparing circuit 28 outputs “0” (in case of any gradation except for D₅₈, since output of switching circuit 67 is cut off by switching circuit 25 and does not contribute display output data 38, no specific explanation thereof is made). As a consequence, an output 73 of the NAND circuit 65 becomes such a signal produced by inverting an LSB of an output 54 (N1) of the 4-frame counter 43 when such a gradation which requires the FRC function is inputted, whereas the output 73 of the NAND circuit 65 always “1” when the gradation D₅₉, D₆₁, D₆₃ which do not require the FRC function are inputted. As described in the switching circuit 67 of FIG. 4, when the output 73 of the NAND circuit 65 is “1”, an output 79 of the dividing circuit 64 becomes a switched output (=output 61 of the 2-frame FRC processing circuit) via the switching circuit 67. Also, when the output 73 of the NAND circuit 65 becomes “0”, an output 76 of the subtracting circuit becomes the above-described switched output (61) via the switching circuit 67.

As a consequence, as previously described, when the gradation which does not require the FRC function is inputted as the image data 31, the output 79 of the dividing circuit 64 always becomes the above-described switched output (=output 61 of the 2-frame FRC processing circuit). As a result, when the gradation D₅₉ is inputted, 13 becomes the switched output; when the gradation D₆₁ is inputted, 14 becomes the switched output; and when the gradation D₆₃ is inputted, 15 becomes the switched output, namely, becomes the output 61 of the 2-frame FRC processing circuit.

On the other hand, when the gradation D₆₀ and D₆₂ which require the FRC function are entered as the image data 31, a switched output (=output 61 of the 2-frame FRC processing circuit) becomes such a signal that the lower 4-bit value of the output 79 of the dividing circuit 64 and the value 76 obtained by subtracting the lower 4-bit value by “1” by the subtracting circuit 66 are alternately switched every frame under switching control of the signal (namely, NAND output 73) obtained by inverting the LSB of the output 54 (N1) of the 4-frame counter 43. As previously described, since the lower 4-bit value becomes 14 when the gradation D₆₀ is entered, and becomes 15 when the gradation D₆₂ is entered, the output 61 of the switching circuit 67 constitutes such a signal that 14 and 13 are alternately switched (averaged value is 13.5) every frame when the gradation D₆₀ is entered, and the output 61 of the switching circuit 67 constitutes such a signal that 15 and 14 are alternately switched (averaged value is 14.5) every frame when the gradation D₆₂ is entered. In other words, when the gradations D₆₀ and D₆₂ are entered, while 2 (second frame number) frames are employed as one set, the outputs become pseudogradation which constitute respective intermediate values by the FRC.

Next, a description is made of the 5-frame FRC processing circuit 29 in FIG. 4, the subtracting circuit 60, and the adding circuit 86. First of all, the 5-frame FRC processing circuit 29 shown in FIG. 4 has the same arrangement as that of the 5-frame FRC processing circuit 29 which has already been explained in the above-described embodiment 1. In order to avoid that the description of this 5-frame FRC processing circuit 29 shown in FIG. 4 is repeatedly made to become redundant, the same reference numerals thereof will be employed as those for denoting such structural elements having the same, or similar functions, and thus, explanations thereof are omitted. It should be understood that a value of an output 34 of the 5-frame counter 23 is recited as “N2”; a value of a quotient of the dividing circuit 24 is recited as “Q2” and a value of a remainder thereof is recited as “R2”; and also, a value of an output 36 of the adding circuit 26 is recited as “Q2+1”, and then, numeral value of “2” is added to a second character of each of symbols. Although these symbols added with “2” are different from the corresponding symbols of the embodiment 1, these symbols added with “2” are to be discriminated from those employed in the above-described 4-frame FRC processing circuit 49, and therefore, the respective symbols added with “2” imply that if “2” is deleted therefrom, then the deleted symbols become identical to those of the above-explained embodiment 1.

Subsequently, different points from the above-described embodiment 1 will now be described in detail. More specifically, an input/output relationship of the 5-frame FRC processing circuit 29 will now be explained in detail. As shown in FIG. 4, an output (namely, image data 31) of the line memory 21 passes through the 4-frame FRC processing circuit 49, and then, is entered to the subtracting circuit 60. The subtracting circuit 60 uniformly subtracts a constant of 24 from the image data 31. As a result, a subtracting circuit output 71 which has passed through the subtracting circuit 60 becomes “D′₀” when the image data 31 is the gradation D₂₄; the subtracting circuit output 71 becomes “D′₁” when the image data 31 is the gradation D₂₅, . . . , the subtracting circuit output 71 becomes “D′₃₄” when the image data 31 is the gradation D₅₈. As described above, the subtracting circuit output 71 (namely, input of subtracting circuit 24) is replaced by such an image data whose range is D′₀ to D′₃₄ (symbols “′” applied after symbol D and symbol G indicate either gradation from which predetermined constant after passing through subtracting circuit is subtracted or specific gradation). As a consequence, operations of the 5-frame FRC processing circuit 29 within such a range that the input gradation (namely, subtracting circuit output 71) is D′₀ to D′₃₄ becomes identical to the operations of the 5-frame FRC processing circuit 29 within the range from D₀ to D₃₄ as previously explained in the embodiment 1. Accordingly, the 5-frame FRC processing circuit 29 is capable of producing 4 pieces of pseudogradation between adjacent gradation within the specific gradation from G′₀ to G′₇ by the FRC function based upon 7 pieces of gradation from G′₀ to G′₆, while employing the comparing function of the comparing circuit 22. For instance, as to uppermost grade gradation D′₃₄ using the 5-frame FRC processing circuit 29, if a gradation value 34 of the gradation D′₃₄ is divided by a constant of 5, then a quotient thereof becomes 6 and a remainder thereof becomes 4. As a result, when the subtracting circuit output 71 is the gradation D′₃₄, the specific gradation G′₇ is outputted for four frames within the 5 frames, and the specific gradation G′₆ is outputted for one frame within the 5 frames from the switching circuit 27 as the switched output (=output 37 of the 5-frame FRC processing circuit).

Next, the switched output of the switching circuit 27, namely, the output 37 of the 5-frame FRC processing circuit is inputted to the adding circuit 86 so as to be added with a constant of 6, so that a range of the adding circuit output 77 outputted from the adding circuit 86 becomes G₆ to G₁₃. Based upon the control function of the switching circuit 25 of the comparing circuit 28, the adding circuit output 77 becomes the display data 38 in correspondence with such a case that the image data 31 is the gradation D₂₄ to D₅₈, and at this time, specific gradation outputted to the data driver unit 4 is G₆ to G₁₃. It should be understood that the specific gradation G₁₃ is used in a time divisional manner every frame in combination with the specific gradation G₁₂ in the pseudogradation display from the gradation D₅₆ to D₅₈.

As previously described, while considering the FRC processing operation of the 5-frame FRC processing circuit 29 in combination with the function of the input-sided subtracting circuit 60 and the function of the output-sided adding circuit 86, this 5-frame FRC processing circuit 29 is operated as follows: That is, while the comparing function of the comparing circuit 22 is employed in correspondence with the gradation D₂₄ to D₅₈, the 5-frame FRC processing circuit 29 produces 4 pieces of the pseudogradation between the respective adjacent gradation of the specific gradation G₆ to G₁₃ by the FRC function based upon the 7 specific gradation from G₆ to G₁₂. As a consequence, a total number of gradation including the specific gradation and the pseudogradation becomes 7×5=35, so that the 5-frame FRC processing circuit 29 may realize 35 gradation equivalent to 6 bits in correspondence with the gradation D₂₄ to D₅₈.

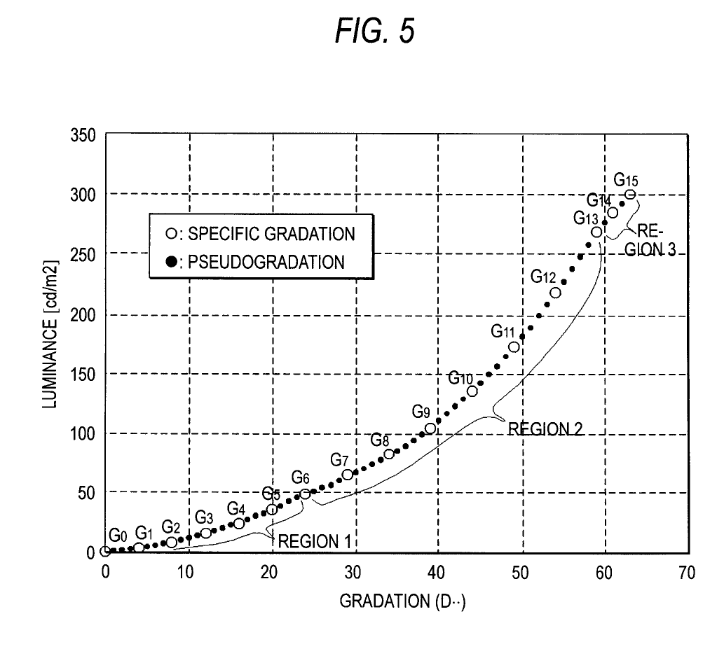

That is to say, while the FRC processing circuit 20 has been constituted by the 2-frame FRC processing circuit 69, the 4-frame FRC processing circuit 49, the 5-frame FRC processing circuit 29, and the adding/subtracting circuits, this FRC processing circuit 20 can realize the 64 gradation defined from D₀ to D₆₃ by the below-mentioned method; Namely, since the 4-frame FRC processing circuit 49 (for 24 pieces of gradation) is used when the gradation of the image data 31 is such a range from D₀ to D₂₃ (region 1 in FIG. 5); the 5-frame FRC processing circuit 29 (for 35 pieces of gradation) is used when the gradation of the image data 31 is such a range from D₂₄ to D₅₈ (region 2: first region in FIG. 5); and also, the 2-frame FRC processing circuit 69 (for 5 pieces of gradation) is used when the gradation of the image data 31 is such a range from D₅₉ to D₆₃ (region 3: second region in FIG. 5); the FRC processing circuit 20 can realize the above-described 64 gradation based upon the specific gradation and the pseudogradation which is produced by switching the specific gradation every frame.

FIG. 5 represents one example of a gradation characteristic of the above-explained 64 gradation, namely, a luminance characteristic (namely, gradation-to-luminance characteristic) of the image data 31 and the liquid crystal display device 1 in the embodiment 2. FIG. 3 shows such a gradation-to-luminance characteristic when the gradation is set by the FRC by the embodiment 2 of the present invention. Similar to the above-described embodiment 1, plotted symbol of “0” indicates luminance of each of the 4-bit specific gradation (represented by G₀ to G₁₅), whereas plotted symbol of “” indicates luminance of 6-bit intermediate gradation which are produced in the pseudomanner by employing the FRC. In the embodiment 2, the gradation D₅₉, the gradation D₆₁, and the gradation D₆₃ are made in correspondence with 4-bit specific gradation G₁₃, G₁₄, G₁₅, which can be directly outputted from the data driver unit 4 irrespective of the FRC. Then, the gradation D₆₀ is formed by the pseudogradation by the FRC while 2 frames of the 4-bit specific gradation G₁₃ and G₁₄ are employed as one set. Similarly, the gradation D₆₂ is formed by the pseudogradation by the FRC while 2 frames of the 4-bit specific gradation G₁₄ and G₁₅ are employed as one set.

On the other hand, since the 4-bit gradation number is 16 pieces of the gradation, which can be directly outputted from this data driver unit 4, the 6-bit gradation D₀ to D₅₈ must be produced by the FRC based upon the remaining 13 gradation. As a consequence, while the frame number of the FRC using the 4-bit gradation G₆ to G₁₃ is assumed as 5 frames, 4 pieces of pseudogradation are formed between the respective adjacent gradation, and 3 pieces of pseudogradation are formed between the respective adjacent gradation of the 4-bit specific gradation G₀ to G₆ by the FRC in the 4 frames.

As previously described, if the image display method according to the embodiment 2 of the present invention is employed, then the below-mentioned advantages may be obtained. That is, with respect to such an image display apparatus having the field angle depending characteristic known as a liquid crystal display device, in a gradation region in which a gradient of a gradation-to-luminance characteristic caused by an angle of field becomes steep (namely, in embodiment 2, gradation region whose specific gradation is G₁₃ to G₁₅), since the frame number of the pseudogradation by the FRC is decreased, even when the field angle is deflected, the image display apparatus can display the image in the multi-gradation mode while the flickering can be reduced. Also, in the embodiment 2 of the present invention, in such a gradation region other than the gradation region where the gradient of the gradation/luminance characteristic becomes steep due to the field angle, the gradation where the frame number of the pseudogradation by the FRC is increased can be relatively decreased. As a result, there is no possibility that the flickering as to large pieces of the gradation is increased.

It should be understood that in the description of the embodiment 2, as one embodiment (namely, example of display device employing NW-TN LCD panel) of the gradation region in which the gradient of the gradation/luminance characteristic becomes steep when the field angle is deflected along the specific direction (namely, gradation region without using FRC), the higher gradation region of the specific gradations G₁₃ to G₁₅ has been employed.

However, in a liquid crystal display device, with respect to each of multiple liquid crystal modes and each of liquid crystal orientation statuses, such a relationship among a range of gradation regions in which gradients of gradation-to-luminance characteristics become steep and thus flickering can be easily and visibly confirmed, directions and angles along which a field angle from a normal direction of the liquid crystal display device is deflected is not constant. Accordingly, it is necessarily required to set such a gradation region where the frame number of the pseudogradation by the above-described FRC is decreased in correspondence with a predetermined field angle direction and a preselected angle by a visible test, or the like, while each of the field angle depending characteristics of the gradation/luminance characteristics as to various sorts of liquid crystal display device is grasped.

The above-described setting of the gradation region may be similarly applied to display devices other than liquid crystal type display devices.

### Embodiment 3

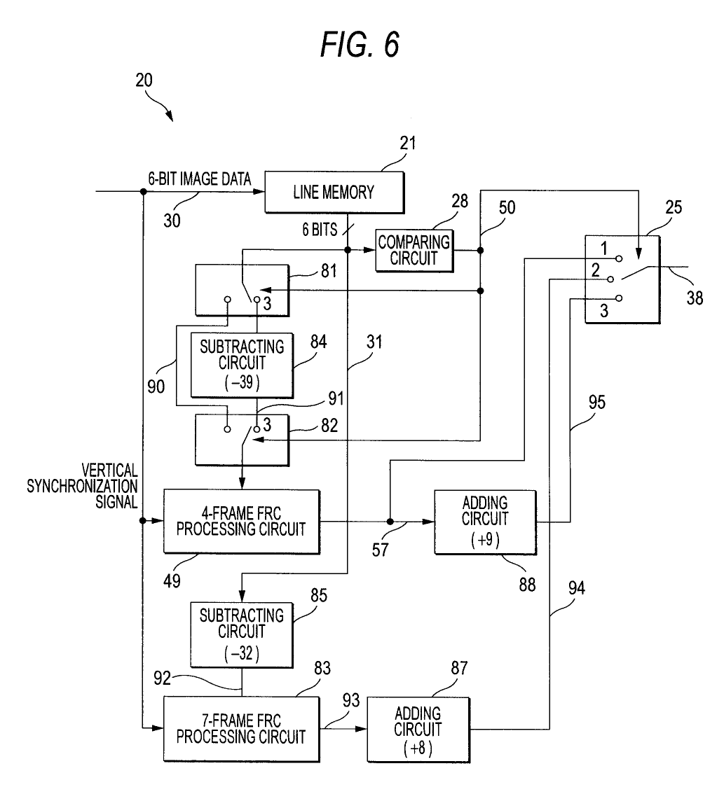

With respect to a liquid crystal display device according to an embodiment 3 of the present invention, schematic arrangements of signal processing circuits and the like except for a liquid crystal panel, a data driver unit, a scanning driver unit, and an FRC circuit are the same as those of the above-described embodiments 1 and 2, and therefore, detailed descriptions thereof are omitted. A detailed description is made of different points from the embodiment 1. FIG. 6 is a structural diagram of an FRC processing circuit 20 according to this embodiment 3. In FIG. 6, a line memory 21 corresponds to such a memory for storing thereinto image data 30 for 1 line which is displayed on a liquid crystal panel 2 in order to perform a signal processing operation later. A structure and a function of this line memory 21 are identical to those of the embodiment 1, and thus, detailed explanations thereof are omitted.

The FRC processing circuit 20 provided in the embodiment 3 has been arranged by a 4-frame FRC processing circuit 49, a 7-frame FRC processing circuit 83, and also, two sets of adding/subtracting circuit. A comparing circuit 28 selectively switches an output 57 of the 4-frame FRC processing circuit, an output 94 of the adding circuit, and an output 95 of the adding circuit based upon values of gradations (D₀ to D₆₃) of the image data 31 so as to produce display data 38.

Precisely speaking, the comparing circuit 28 controls the switching circuit 25 in such a manner that when the image data 31 has the gradations D₀ to D₃₁, the switching circuit 25 is switched to the output 57 of the 4-frame FRC processing circuit; when the image data 31 has the gradation D₃₂ to D₃₈, the switching circuit 25 is switched to the output 94 of the adding circuit 87; and also, when the image data 31 has the gradation D₃₉ to D₆₂, the switching circuit 25 is switched to the output 95 of the adding circuit 88. An output of the switching circuit 25 is entered as the display data 38 to the data driver unit 4, while the output thereof is any one of the specific gradation G₀ to G₁₅.

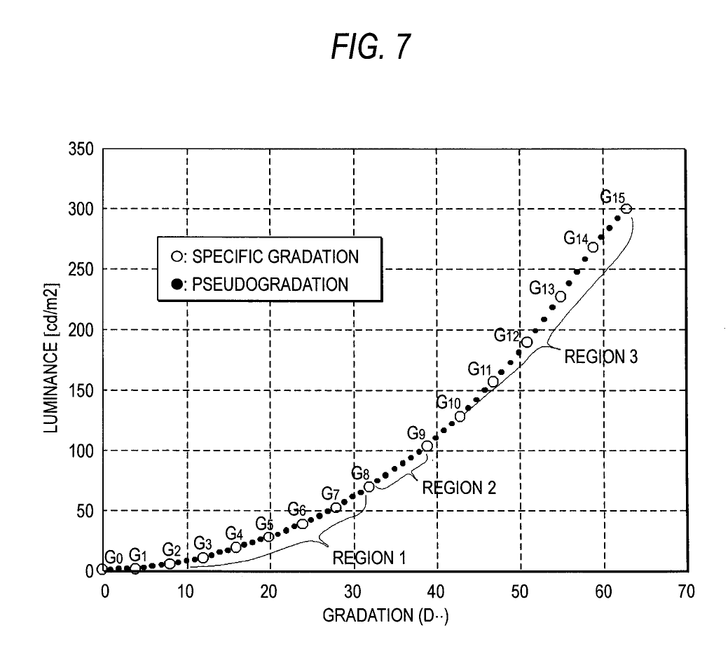

In this case, since an internal arrangement and operations of the 4-frame FRC processing circuit 49 are identical to those of the above-described embodiment 2, detailed descriptions thereof are omitted. A detailed description is made of input/output circuits as to the 4-frame FRC processing circuit 49. Firstly, in such a case that the image data 31 is present in a range of the gradation D₀ to D₃₁ (region 1 in FIG. 7), a signal which is inputted to the 4-frame FRC processing circuit 49 is controlled in such a manner that this signal is entered via a switching circuit 81, a wiring line 90, and another switching circuit 82 to the 4-frame FRC processing circuit 49 in response to the switching control signal 50 of the comparing circuit 28. As a consequence, similar to the above-described embodiment 2, while the output of the 4-frame FRC processing circuit 49 corresponds to the gradation D₀ to D₃₁ of the image data 31, the 4-frame FRC processing circuit 49 produces 3 pieces of the pseudogradation between the respective adjacent gradation of the specific gradation G₀ to G₈ by the FRC function based upon the 8 specific gradation from G₀ to G₇ within the range of the specific gradation G₀ to G₈. As a consequence, a total number of gradation including the specific gradation and the pseudogradation becomes 8×4=32, so that the 4-frame FRC processing circuit 49 may realize 35 gradation equivalent to 6 bits in correspondence with the gradation D₀ to D₃₁.

Next, a description is made of such a case that the image data 31 is present in a range (region 2 in FIG. 7) of the gradation D₃₂ to D₃₈. When the image data 31 corresponds to the gradation D₃₂ to D₃₈ (gradation values 32 to 38), the subtracting circuit 85 subtracts a constant of 32 from the image data 31. As a result, an output 92 of the subtracting circuit becomes gradation D′₀ to D′₆ (namely, 0 to 6 as gradation values), and the gradation is inputted to the 7-frame FRC processing circuit 83. In this case, the 7-frame FRC processing circuit 83 has been arranged in such a manner that, for example, the frame counter of the 5-frame counter 23 is increased from 5 to 7 so as to be constructed as a 7-frame counter, and the constant of the dividing circuit is also increased from 5 to 7 in correspondence thereto. This 5-frame counter 23 has been employed in the 5-frame FRC processing circuit 29 as previously explained in the embodiment 1 or 2. Thus, the 7-frame FRC processing circuit 29 can produce 6 pieces of pseudogradation based upon one piece of specific gradation. As a consequence, an output 93 of the 7-frame FRC processing circuit 83 contains 6 pieces of the pseudogradation between the specific gradation G′₀ and G′₁. Furthermore, a range of the adding circuit output 94 where the output 93 of the 7-frame FRC processing circuit 83 is fed via the adding circuit 87 becomes between the specific gradation G₈ and G₉ (8 and 9 provided as gradation values) by adding a constant of 8 to the specific gradation G′₀ and G′₁. Since the specific gradation G₈ of the adding circuit output 94 corresponds to the gradation D₃₂ of the image data 31, the specific gradation G₈ is realized as 6 pieces of such pseudogradation that G₈ and G₉ are outputted in a time divisional mode every frame in correspondence with the gradation D₃₃ to D₃₈.

Next, a description is made of such a case that the image data 31 is present in a range (region 3 in FIG. 7) of the gradation D₃₉ to D₆₃. When the image data 31 corresponds to the gradation D₃₉ to D₆₃ (gradation values 39 to 63), as shown in FIG. 6, an output (namely, image data 31) of the line memory 21 passes through the switching circuit 81, and then, is entered to the subtracting circuit 84. The subtracting circuit 84 uniformly subtracts a constant of 39 from the image data 31. As a result, a subtracting circuit output 91 which has passed through the subtracting circuit 84 becomes “D′₀” when the image data 31 is the gradation D₃₉; the subtracting circuit output 71 becomes “D′₁” when the image data 31 is the gradation D₄₀, . . . , the subtracting circuit output 71 becomes “D′₂₄” when the image data 31 is the gradation D₆₃. Subsequently, the subtracting circuit output 91 is entered via the switching circuit 82 to the above-explained 4-frame FRC processing circuit 49. As explained above, the subtracting circuit output 91 is replaced by such an image data whose range is D′₀ to D′₂₄. As a consequence, operations of the 4-frame FRC processing circuit 49 within such a range that the input gradation (namely, subtracting circuit output 91) is D′₀ to D′₂₄ is made identical to the operations when the image data 31 is in the range from D₀ to D₃₁. Accordingly, the 4-frame FRC processing circuit 49 is capable of producing 3 pieces of pseudogradation between adjacent gradation within the specific gradation from G′₀ to G′₆ by the FRC function based upon 6 pieces of gradation from G′₀ to G′₅, due to the FRC function of the 4-frame FRC processing circuit 49. For instance, as to the gradation D′₂₃ using the 4-frame FRC processing circuit 49, if a gradation value 23 of the gradation D′₂₃ is divided by a constant of 4, then a quotient thereof becomes 5 and a remainder thereof becomes 3. As a result, when the subtracting circuit output 91 is the gradation D′₂₃, the specific gradation G′₅ is outputted for three frames within the 4 frames, and the specific gradation G′₆ is outputted for one frame within the 5 frames as the output 57 of 4-frame FRC processing circuit 49. Next, the adding circuit 88 inputs the output 57 of the 4-frame FRC processing circuit to add the constant of 9, and thereby the output 95 of the adding circuit is output into the switching circuit 25.

As previously described, in the embodiment 3, within the range (namely, region 1+region 3: first region shown in FIG. 7) where the image data 31 has the gradation D₀ to D₃₁ and the gradation D₃₉ to D₆₃, the 4-frame FRC processing circuit 49 is used in which 4 (first frame number) frames are defined as one set, whereas within the region (region 2: second region shown in FIG. 7) where the image data 31 has the gradation D₃₂ to D₃₈, the 7-frame FRC processing circuit is employed in which 7 (second frame number) frames are defined as one set.

FIG. 7 represents one example of a gradation characteristic of the above-explained 64 gradation, namely, a luminance characteristic (namely, gradation-to-luminance characteristic) of the image data 31 and the liquid crystal display device 1 in the embodiment 3. FIG. 7 shows such a gradation-to-luminance characteristic when the gradation is set by the FRC by the embodiment 3 of the present invention. Similar to the above-described embodiments 1 and 2, plotted symbol of “∘” indicates luminance of each of the 4-bit specific gradation (represented by G₀ to G₁₅), whereas plotted symbol of “” indicates luminance of 6-bit intermediate gradation which are produced in the pseudomanner by employing the FRC. Three pieces of pseudogradation are formed by executing the FRC where four frames are defined as one set between the respective adjoining specific gradation of the 4-bit specific gradations G₀ to G₈ and G₉ to G₁₅. As a result, a total number of the gradation which can be displayed becomes 58 pieces by adding 16 pieces of the specific gradation outputted from the data driver unit 4 irrespective of the FRC to 42 pieces of the pseudogradation which are produced by performing the FRC. As to the total 58 pieces of the gradation, there is a lack of 6 gradation with respect to a total number (64) of j-bit gradation to be displayed. Accordingly, 6 pieces of pseudogradation are produced by executing the FRC for defining 7 frames as one set by employing the 4-bit specific gradations G₈ and G₉.

As disclosed in JP-A-10-339865 and H. Mori, H. Itoh, Y. Nishiura, T. Nakamura and Y. Shinagawa “Optical Performance of Novel Compensation Film for Wide-Viewing-Angle TN-LCDs”, pages 189 to 192, Proc. IDW ‘96/AM-LCD’ 96, as to the gradation-to-luminance characteristic in the vicinity of the 4-bit specific gradation G₈ and G₉, even when the field angle is deflected, the characteristic thereof does not become steep, but also, even when the frequency of the brightness variation is relatively low such as 7 frames, a difference between the luminance of two pieces of the gradation is not increased. As a result, flickering does not become conspicuous.

As previously described, in accordance with the embodiment 3 of the present invention, in such a case that j-bit image data is displayed by an i-bit data driver unit (note that i<j), pseudogradation is formed between respective i-bit gradation by performing such an FRC that 2^{(j-i)} frames are defined as one set. Also, as to a shortage of gradation number with respect to 2^{j} gradation numbers, the short number of gradation is formed by such an FRC that a plurality of frames larger than the above-described 2^{(j-i)} frames are defined as one set in such a gradation region (namely, gradation region between specific gradation G₈ and G₉ in embodiment 3) that an apparent luminance difference is not increased when a field angle is deflected. As a result, even when the field angle is deflected, the 2^{j} gradation display can be realized while the flickering does not become conspicuous.

In addition, since a total number of the pseudogradation and a range of the pseudogradation in the region 2 are properly set, and also, total numbers of the pseudogradation of the regions 1 and 3 are properly set within such a range that no flickering occurs, (2^{j}-2ⁱ) pieces, or more larger pieces of the pseudogradation in total may be alternatively produced within all of these gradation regions.

It should be understood that in the description of the embodiment 3, as one embodiment (namely, example of display device employing NW-TN LCD panel) of the gradation region in which the gradient of the gradation/luminance characteristic is not increased when the field angle is deflected along the specific direction (namely, gradation region without using FRC), the intermediate gradation region has been exemplified.

However, in a liquid crystal display device, with respect to each of multiple liquid crystal modes and each of liquid crystal orientation statuses, such a relationship among a range of gradation regions in which gradients of gradation-to-luminance characteristics become steep and thus flickering can be easily and visibly confirmed, directions and angles along which a field angle from a normal direction of the liquid crystal display device is deflected is not constant. Accordingly, it is necessarily required to set such a gradation region where the above-described FRC based upon the relatively large frame number is applied in correspondence with a predetermined field angle direction and a preselected angle by a visible test, or the like, while each of the field angle depending characteristics of the gradation/luminance characteristics as to various sorts of liquid crystal display device is grasped.

The above-described setting of the gradation region may be similarly applied to display devices other than liquid crystal type display devices.

### Embodiment 4

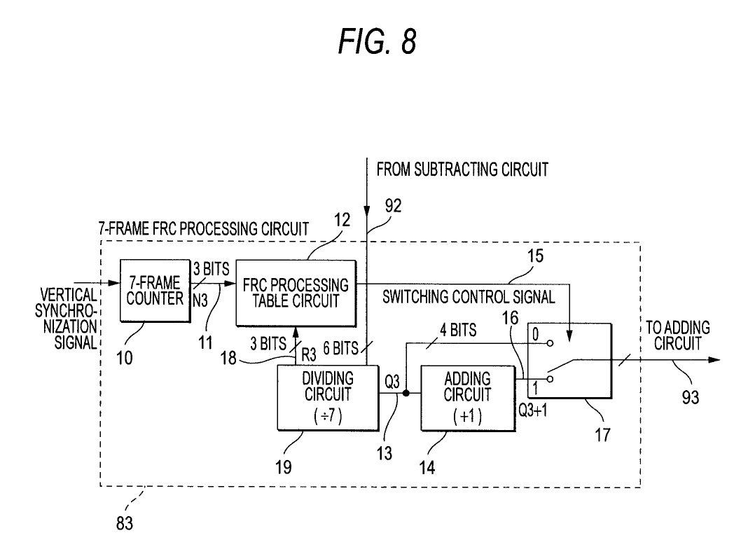

With respect to a liquid crystal display device according to an embodiment 4 of the present invention, schematic arrangements of signal processing circuits and the like except for a liquid crystal panel, a data driver unit, a scanning driver unit, and a 7-frame FRC processing circuit 83 are the same as those of the above-described embodiment 3, and therefore, detailed descriptions thereof are omitted. A detailed description is made of different points from the embodiment 3. FIG. 8 is a structural diagram of the 7-frame FRC processing circuit 83 according to this embodiment 4. In FIG. 8, an FRC table processing circuit 12 has been employed in the 7-frame FRC processing circuit 83 instead of the comparing circuit for comparing the remainder “R” with the frame number “N”, which has been used in the above-described embodiments 1 to 3.

The FRC table processing circuit 12 is equipped with a data table (which is arranged by storage unit such as read-only memory) which has stored thereinto an FRC control table shown in a table 1. The FRC table processing circuit 12 outputs either “0” or “1” of an FRC control output Q3 from a frame number N3 (11) and a remainder R3 (18), which are inputted. One embodiment of the above-described data table is represented in the table 1.

TABLE 1

| | | count value (N3) | | | | | | |
|---|---|---|---|---|---|---|---|---|
| | | 0 | 1 | 2 | 3 | 4 | 5 | 6 |
| remainder | 0 | 0 | 0 | 0 | 0 | 0 | 0 | 0 |
| (R3) | 1 | 1 | 0 | 0 | 0 | 0 | 0 | 0 |
| | 2 | 1 | 0 | 0 | 1 | 0 | 0 | 0 |
| | 3 | 1 | 0 | 1 | 0 | 1 | 0 | 0 |
| | 4 | 1 | 0 | 1 | 0 | 1 | 0 | 1 |
| | 5 | 1 | 1 | 0 | 1 | 1 | 1 | 0 |
| | 6 | 1 | 1 | 1 | 0 | 1 | 1 | 1 |

When image data (namely, subtracting circuit output 92) to be inputted is constant, a remainder R3 (18) calculated by dividing this image data by 7 is a constant value. Referring now to the above-described table 1, in accordance with such a condition that a frame count value N3 (11) to be inputted is circulated in this order of 0, 1, 2, 3, . . . , 6, 0, 1, . . . , either the value “0” or the value “1” contained in 1 row, which corresponds to the remainder R3 (18), is sequentially sent out from the FRC table processing circuit 12 to a switching circuit 17 as a switching control signal 15. The switching circuit 17 switches a quotient Q3 (13) of a dividing circuit 19 and a value of “Q3+1 (16)” obtained by adding a constant of 1 to this quotient Q3 (13) based upon the above-explained switching control signal 15, and then, outputs the switched result to an adding circuit 87. Precisely speaking, when the switching control signal 15 is “0”, the quotient Q3 (13) of the dividing circuit 19 is selected by the switching circuit 17, whereas when the switching control signal 15 is “1”, the added result “Q3+1 (16) ” of the adding circuit 14 is selected by the switching circuit 17, so that the selected result is outputted as an output 93 of the 7-frame FRC processing circuit.

As apparent from the table 1, when an attention is paid to one row corresponding to the remainder (R3) described in the table 1, a total number of the value “1” recited in a section (cell) corresponding to the count values (N3) from 0 to 6 is made coincident with the value of the remainder (R3), and the added result Q3+1 (16) of the adding circuit 14 is selected by plural times equal to the times of the remainder (R3) within 7 frames. As a consequence, a total number of the value “0” recited in the above frames becomes 7—the remainder (R3), and an execution value of specific gradation which is averaged within the 7 frames is given as {(7-remainder R3)×Q3}/7+{remainder R3×(Q3+1)}/7. Thus such a gradation value is obtained which is similar to that when the comparing circuit is used.

Also, for example, when an attention is paid to a frame of a row in the case that the remainder R3 is 4 in this table 1, the following fact can be revealed. That is, the switching control signal 15 is changed in this order from 1, 0, 1, 0, 1, 0, 1 in response to such a condition that the count value N3 is sequentially increased from 0. This implies that both “0” and “1” alternately constitute the switching control signal 15 every frame except for 1 time when the frame count value N3 (11) is returned from 6 to 0. As a result, as the switched output (=7-frame FRC processing circuit output 93), the quotient Q3 (13) and the added result Q3+1 (16) are alternately outputted every frame. This implies such a gradation that pseudogradation using the specific gradation value Q3 and Q3+1, which are inputted to the data driver unit 4, is varied every frame except for 1 time within the 7 frames. This variation period becomes 2 frames. As a consequence, this pseudogradation contains a large number of relatively high frequency components, so that flickering can be hardly and visibly recognized.

Also, in the case that the remainder R3 is 2, 3, and 5, since a total number of the value “1” contained in 1 row is similarly made coincident with the total value of the remainder R3, and the arranging way of these values “1” and “0” is adjusted with respect to the above-described data table (namely, contents of table 1), an alternate period of the values “0” and “1” may be easily shortened. As a result, such a liquid crystal display device whose flickering can be hardly and visibly recognized may be alternatively obtained.

Also, a count number of a frame counter, a dividing constant of a dividing circuit, and the content of the FRC control table are properly changed which are employed in the 7-frame FRC processing circuit with employment of the above-described FRC control table, so that a 4-frame FRC processing circuit and a 5-frame FRC processing circuit may be easily realized. As a consequence, the following fact may become apparent. That is, the above-described 4-frame FRC processing circuit and 5-frame FRC processing circuit are employed in the FRC circuit exemplified in the above-explained embodiments 1 to 3, so that a liquid crystal display device whose flickering can be hardly and visibly recognized can be obtained.

It should also be noted that in the above-described embodiments 1 to 4, no specific description has been made as to operations of the respective FRC processing circuits under such a condition that the outputs of the respective frame FRC processing circuits have not be selected by the switching circuit 25 in the explanations as to the operations of the 2-frame FRC processing circuit 69, the 4-frame FRC processing circuit 49, and the 5-frame FRC processing circuit 29, included into the FRC processing circuit 20, and also, the 7-frame FRC processing circuit 83. However, when a driving circuit for a liquid crystal display device and the like is actually designed, the circuit designing should be performed by considering that unexpected data is inputted to the respective FRC processing circuits, but these FRC processing circuits are not erroneously operated. Alternatively, such a measure capable of preventing an input of the unexpected data may be taken by adding such a switching circuit which may properly distribute outputs of the line memory 21 to the respective FRC processing circuits.

What is claimed is:

1. A display method comprising:
when a first bit number of image data inputted to an image display device is larger than a second bit number of display data inputted to a driver unit for driving a display unit, displaying an image of the image data on the image display device in gradation of the first bit number; and
providing predetermined regions in a graduation region of the driver unit, the predetermined regions comprising:
a first region where a frame rate control is performed by defining a first frame number as one set so as to produce pseudogradation; and
a second region where the frame rate control is not carried out,
wherein the second region is such a gradation region that when a field angle of the image display device is deflected from the normal direction to a predetermined field angle direction, or a predetermined angle, a gradient of a gradation-to-luminance characteristic becomes steep.

2. The image display method according to claim 1,
wherein the gradation of the first bit number is displayed based upon a data table.

3. A display method comprising:
when a first bit number of image data inputted to an image display device is larger than a second bit number of display data inputted to a driver unit for driving a display unit, displaying an image of the image data on the image display device in gradation of the first bit number; and
providing predetermined regions in a graduation region of the driver unit, the predetermined regions comprising:
a first region where a frame rate control is performed by defining a first frame number as one set so as to produce pseudogradation; and
a second region where the frame rate control is carried out by defining a second frame number smaller than the first frame number as one set so as to produce pseudogradation,
wherein the second region is such a gradation region that when a field angle of the image display device is deflected from the normal direction to a predetermined field angle direction, or a predetermined angle, a gradient of a gradation-to-luminance characteristic becomes steep.

4. The image display method according to claim 3,
wherein the gradation of the first bit number is displayed based upon a data table.

5. A display method comprising:
when a first bit number of image data inputted to an image display device is larger than a second bit number of display data inputted to a driver unit for driving a display unit, displaying an image of the image data on the image display device in gradation of the first bit number; and
providing predetermined regions in a gradation region of the image display device, the predetermined regions comprising:
a first region where a frame rate control is performed by defining a first frame number as one set so as to produce pseudogradation; and
a second region where the frame rate control is carried out by defining a second frame number smaller than the first frame number as one set so as to produce pseudogradation,
wherein the second region is set to a gradation region other than such a region where when a field angle of the image display device is deflected from the normal direction to a predetermined field angle direction, or a predetermined angle, a gradient of a gradation-to-luminance characteristic becomes steep.

6. The image display method according to claim 5,
wherein, when the first bit number is selected to be “j” and the second bit number is selected to be “i”, a quantity of gradation produced by the frame rate control is large than, or equal to 2^{j}-2ⁱ.

7. The image display method according to claim 5,
wherein the gradation of the first bit number is displayed based upon a data table.

8. An image display device employing the image display method according to claim 1.
